(19) United States
(12) Patent Application Publication
(10) Pub. No.: US 2022/0144706 A1
(43) Pub. Date: May 12, 2022

(54) HIGH STRENGTH, TOUGH, COAL AND COAL BY-PRODUCT BASED COMPOSITE CERAMICS

(71) Applicant: Semplastics EHC, LLC, Oviedo, FL (US)

(72) Inventors: Arnold Hill, Orlando, FL (US); Walter Sherwood, Ballston Lake, NY (US); Ryan Trammell, Lake Mary, FL (US); William Easter, Chuluota, FL (US)

(21) Appl. No.: 17/091,083

(22) Filed: Nov. 6, 2020

(51) Int. Cl. C04B 35/532; C04B 35/634; C04B 35/628; C04B 35/626; C04B 18/02

(52) U.S. Cl. CPC C04B 35/532; C04B 2111/00612; C04B 35/628; C04B 35/62695; C04B 35/6261; C04B 18/022; C04B 2235/422; C04B 2235/483; C04B 2235/5454; C04B 2235/5445; C04B 2235/5436; C04B 2235/6021; C04B 2235/604; C04B 2235/656; C04B 35/63448

(57) ABSTRACT

A composite material, compositions, processes and methods of using coal and coal by-products composite ceramics is provided for use as a safe, non-toxic material for construction, building and architecture components. The composite material disclosed herein is formed from resin/coal aggregates that contain and prevent the release of harmful impurities that naturally occur in both coal and coal by-products while the advantages of coal-based composites are made available to the building industry. The strength, density and porosity of the composites can be tailored within a wide range to fit the final application by controlling the materials, form factor and processing parameters during fabrication.

### GOVERNMENT LICENSE RIGHTS

This invention was made with Government support under U.S. Department of Energy Contract No. DE-SC0018794 awarded by the Department of Energy. The government has certain rights in this invention.

### FIELD OF INVENTION

This invention relates to composites, and in particular to composite materials, compositions, processes and methods for forming composite ceramics materials based on the non-combustion use of coal and coal by-products in construction materials and building/architecture components.

### BACKGROUND AND PRIOR ART

As a fossil fuel, coal is responsible for a large chunk of greenhouse gas emissions and air pollution produced worldwide. The five largest coal users are China, USA, India, Russia and Japan. In an effort to cut greenhouse gas emissions around the world, coal has become an unpopular fuel in the world's energy portfolio, and alternative fuels are being sought to fill the gap. Thus, the coal industry has suffered from the loss of jobs and is now known as a declining industry.

Coal is relatively cheap; so other businesses are looking to find ways to use coal not only to salvage jobs, but also to help the construction industry become more sustainable. For years, coal-fired power plants discharged fly ash as a by-product of burning coal to produce electricity. In the early 1990s, the fly ash by-product was found useful in the manufacture of concrete with fly ash being a substitute for a portion of the cement. Coal and by-products of coal combustion have also been used in asphalt paving materials, as well as-masonry blocks. Scientific articles have been published on the subject of finding alternative, non-combustive uses for coal. James Conca wrote, “Coal Doesn't Have to Die—We Can Make Furniture Out Of It”, Energy, Jul. 14, 2013 (Online at www.forbes.com/sites/jamesconca) suggesting that coal could replace wood in new carbon-based industries with “. . . products such as furniture, utility poles, home-construction materials, beams, ropes, industrial belts, car bodies . . . ” and more.

In Energy & Environment, Jun. 20, 2017, (Available online at www.triplepundit.com) Leon Kay wrote an article entitled, “Could Coal Find a New Life as a Green Building Material?” Kay discloses the advantages coal brings to the building industry—improved product durability, lower costs . . . , coal degrading . . . and the like.

There is discussion in a research article entitled, “Coal-Filler-Based Thermoplastic Composites as Construction Materials: A New Sustainable End-Use Application” by Yahya A. Al-Majali et al., ACS Sustainable Chem. Eng. 2019, 7 (19), 16870-16878 concerning the advantages of coal as a filler in construction materials. The research indicated that the direct utilization of coal as a filler in construction composite applications may yield lower-cost products with lower associated emissions and energy demand during manufacture compared to that of existing wood plastic composite materials, potentially yielding a more sustainable end use for coal than current uses, such as, in power production.

In spite of the good news for the potential use of coal in the building or construction industry, there is cause for concern. Coal is a material that's full of impurities, harmful substances, and heavy metals such as, Antimony (Sb) arsenic (As) boron (B) barium (Ba), cadmium (Cd), chromium (Cr), molybdenum (Mo), lead (Pb), selenium (Se), thallium (Tl), vanadium (V). Heavy metals like arsenic, lead and selenium are known to cause cancer and other health problems.

Fly ash is a cocktail of the same toxic chemicals—it contains the same heavy metals that are found in coal, only in higher concentrations. Fly ash is generally believed to be fairly safe because, even though it has the same heavy metals as coal, the harmful effects are thought to be neutralized when fly ash is added to the calcium compound (lime) in the concrete mixes. Although it is believed that the toxic elements in the fly ash will not leach out of the concrete over time, the fact that concrete is porous and subject to damage by road salt and acid rain, suggests that there are still some concerns about the validity of those claims. Exposure of human and animal subjects to dangerous chemicals can lead to birth defects, cancer, and even death.

Although it is currently very low cost, the use of coal in building and construction materials in the same manner as fly ash presents a number of impediments, including the fact that coal due to its organic nature is not compatible with any cement or concrete based construction material as it repels water and will not mix with cement or concrete formulations. Impediments to using coal in other applications such as a filler in plastic resins include:
Coal is flammable so simply using it as a filler in plastics would require more fire retardants in the plastic, further degrading performance
Coal compositions, including the amount of toxic elements, water content, the amount of organic volatiles, and the ash content, all vary depending on where the coal is mined and what type of coal is used, such as, Anthracite, bituminous, sub-bituminous, lignite and the like. This makes using coal as a filler in plastic material exceedingly difficult and expensive to insert into a production process despite its very low initial cost.
Coal, if added as a filler, has been shown to function like conventional fillers such as talc which impart no improvement to the material and just reduce cost and increase the flammability of the plastic.

The present invention addresses nearly all of the problems with the current state of the art utilizing coal and coal byproducts such as fly ash, and provides compositions and methods to produce construction materials and components that use large percentages of coal or fly ash in the total composition to produce low-cost construction materials and components with superior properties compared to existing construction materials.

### SUMMARY OF THE INVENTION

A primary objective of the present invention is to provide composite materials, compositions, processes and methods for forming composite materials based on the non-combustion use of coal and coal by-products in safe, non-toxic construction materials and building/architecture components.

A secondary objective of the present invention is to provide composite materials, compositions, processes and methods for forming composite materials based on coal and coal by-products wherein the harmful impurities, including, toxic elements and heavy metals, present in both coal and coal by-products are contained and not released into the environment.

A third objective of the present invention is to provide composite materials, compositions, processes and methods for forming composite materials based on coal and coal by-products wherein the harmful impurities present in both coal and coal by-products are contained and not released into the environment when used in construction materials and building/architecture components.

A fourth objective of the present invention is to provide composite materials, compositions, processes and methods for forming composite materials based on coal and coal by-products wherein the harmful impurities present in both coal and coal by-products are contained and not released into the environment and the mechanical properties of the composite materials exceed those of existing load bearing concrete masonry units.

A fifth objective of the present invention is to provide composite materials, compositions, processes and methods for forming composite materials based on coal and coal by-products wherein the coal and coal by-products are processed in a manner that coats and seals in the harmful impurities present in both coal and coal by-products with a polymer-derived ceramic (PDC) matrix to prevent impurities from leaching out during subsequent use of construction materials and building/architecture components made therefrom.

A sixth objective of the present invention is to provide composite materials, compositions, processes and methods for forming composite materials based on coal and coal by-products wherein the coal and coal by-products are processed in a manner that allows the strength, density and porosity of the composites to be tailored to fit the final application by controlling the materials, form factor and processing parameters during fabrication.

Further objects and advantages of this invention will be apparent from the following detailed description of the presently preferred embodiments which are illustrated schematically in the accompanying drawings.

### BRIEF DESCRIPTION OF THE FIGURES

The drawing figures depict one or more implementations in accord with the present concepts, by way of example only, not by way of limitations. In the figures, like reference numerals refer to the same or similar elements.

FIG. 1 is a schematic cross-sectional view showing one embodiment of the inorganic polymer resin coated particle of coal or coal by-product of the present invention that is mixed with multiple coated particles to form afirst aggregate having a single coating of resin.

FIG. 2 is a schematic cross-sectional view showing a second embodiment wherein a plurality of afirst aggregate of coated particles of coal or coal by-product are mixed with a second coating of polymer resin to form a second aggregate having a dual coating of resin that subsequently is formed and processed to produce a fully ceramic composite part.

FIG. 3 is a flow chart of the process for the formation of a coal or coal by-product ceramic aggregate.

FIG. 4 is a flow chart of the process for the formation of a coal or coal by-product ceramic composite part or component.

### DETAILED DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

In the Summary above and in the Detailed Description of Preferred Embodiments and in the accompanying drawings, reference is made to particular features (including method steps) of the invention. It is to be understood that the disclosure of the invention in this specification does not include all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, some embodiments of the invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments.

Other technical advantages may become readily apparent to one of ordinary skill in the art after review of the following figures and description.

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise specifically noted, articles depicted in the drawings are not necessarily drawn to scale.

A list of acronyms and terms used in the discussion of the present invention are described below.

MPa stands for Megapascal and is a metric pressure unit equal to 1,000,000 force of newton per square meter. 1 MPa=145.037737797 psi (pounds per square inch).

PDC stands for “Polymer-derived ceramic” a ceramic material formed by the pyrolysis of a specially designed inorganic pre-ceramic polymer or resin. Non-limiting examples are: silicon oxycarbides, silicon carbides, silicon nitrides, silica.

PHR stands for parts of surfactant per hundred parts of resin.

“Aggregate” describes fine powder particles (approximately 0.01 to approximately 50 micrometers in average diameter) bonded together into larger particles (less than approximately 5 microns to approximately 5 millimeters in average diameter) by either a PDC ceramic or a cured PDC polymer. Particles can be coal, coal by-products, or other materials such as sand, clay, or other inorganic powders. An aggregate particle typically contains more than approximately 10 powder particles.

“Aggregate Binder or Aggregate bonding resin” is the polymer used to bond the aggregate particles together to form the part or component. The binder or bonding resin is typically a PDC polymer, but it is not required. Polyethylene, polypropylene or other organic polymers can also function as the aggregate bonding resin.

“Combined Aggregate” is a mixture of powder particles of different materials bonded together with either PDC ceramic or cured PDC polymer.

“Coal” is defined as a solid material dug from the ground that contains from 35% to 95% carbon depending on the type, such as, but not limited to: Lignite or brown coal: approximately 35-approximately 55% carbon, Sub-Bituminous, Low volatile Bituminous, and Bituminous coal: 40-80% carbon, and Anthracite Coal: 80-95% carbon. Most types of coal are typically burned to provide heat. For this application “Coal” encompasses the standard types of coal: lignite, sub-bituminous, bituminous, low volatile bituminous, and anthracite.

“Coal-Byproducts” are waste materials from either mining the coal, or are left over after coal combustion. Encompassing: garbage of bituminous (GOB, the mix of mostly dirt with some coal found around coal seams), shale-coal, coal combustion residuals (CCR) which includes fly ash, bottom ash, and coke or partially burned coal.

“Curing” means heating to between approximately 50° C. and approximately 210° C. to cure/crosslink the PDC polymer or resin; curing can be done in air or inert gas.

“Diameter” as used herein refers to the “effective/equivalent diameter” of the particles. Even though they are not perfectly spherical, they have effective diameters as if they were perfect spheres.

“Dual-resin coat” as used herein refers to two separate coatings of a pre-ceramic polymer resin wherein the resins can be inorganic polymer, organic polymer or mixtures thereof.

“Monomodal” is used herein to describe particle size distribution wherein the particles are usually of the same size or size variation is within a narrow range.

“Multimodal” is used herein to describe resin-coated coal aggregate particle size in the present invention; the aggregate particles are of various sizes with a wide variation in particle size range, such as from approximately <5 microns to approximately 5 millimeters in effective diameter.

“Multiples” as used herein means more than three and less than twenty five.

“Particle or Powder Coating Polymer or Resin” means the PDC polymer resin used to coat individual particles and bond them together into the aggregate upon curing. This resin is designed such that the aggregate is coated with a material that enhances bonding of the aggregate to the aggregate bonding resin and increases the strength and toughness of the part or component.

“Pre-ceramic polymer or resin” is also discussed as a “PDC Polymer” or “PDC Resin” and means a specially designed inorganic polymer or resin that when heated, forms large amounts of ceramic (>approximately 60% of the original resin mass). The preferred PDC polymer typically is composed of polymer chains that do not have a carbon-based backbone and are thereby termed “inorganic”. Examples of pre-ceramic polymer, include, but are not limited to, siloxanes (have a silicon-oxygen backbone), carbosilanes, silanes, silazanes, and the like.

“Pugmills” are mixers that use dual counter-rotating shafts with affixed pitched paddles to create a kneading and folding-over motion inside of the mixer. The counter-rotating motion lifts material up through the center and then back down the sides, creating an intimate mixture of materials.

“Pyrolysis (pyrolyzing)” describes heating a material in an inert or low oxygen (less than 1% oxygen) atmosphere to a temperature of approximately 700° C. to approximately 1100° C. to convert the PDC polymer or resin into a ceramic material.

“Starting Powder” means a granulated material with a particle size ranging from approximately 0.01 micrometers to approximately 100 micrometers.

X-BRIX is a tradename by Dynamic Material Systems LLC, Oviedo, FL and is used for marketing engineered coal core composite building materials for infrastructure construction and commercial buildings described in the present invention.

X-BLOX is a tradename by Dynamic Material Systems LLC, Oviedo, FL and is used for marketing engineered coal core composite building materials for infrastructure construction and commercial buildings described in the present invention.

X-MAT® is the registered trademark by Dynamic Material Systems, LLC for Polymer derived ceramics and composites made with same used in the manufacture of commercial and industrial goods; ceramic and polymer linkage and linkages of particles with the nature of the linkages being chemically bonded or attached, for use in the manufacture of devices comprised of engineered materials.

All percentages discussed in the disclosure are based on weight percent.

### DETAILED DESCRIPTION OF THE INVENTION

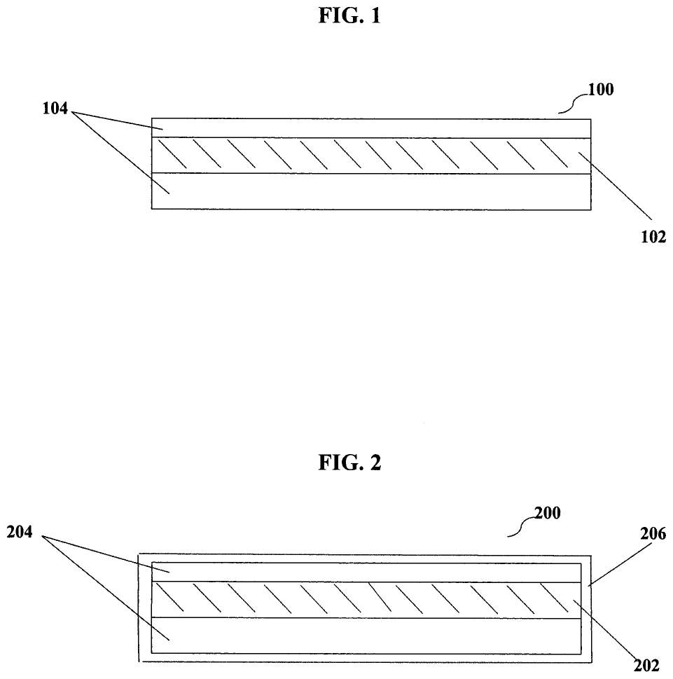

In the present invention, a pre-ceramic polymer resin is used to coat coal or coal-byproduct powders with a thick (>approximately 100 nm) layer of specially formulated resin or PDC ceramic polymer. FIG. 1 shows a schematic cross-sectional view of one particle 100 of coal or coal by-product 102 coated with an inorganic polymer resin 104 to form a resin-coated particle of the present invention.

The coating 104 seals the coal or coal-byproduct powders to minimize or prevent the leaching of toxic elements known to be in coal and coal-byproducts. Many of the toxic elements can be leached out of current fly ash modified concrete by rain action and road salt and ice melt in cold climates areas with temperatures below 0° C.

An additional aspect of the invention over prior art is the intermediate step of forming an “aggregate”. The aggregate is a larger particle or grain that is composed of many (>approximately 10) smaller particles 100 coated and bonded together by a particle coating/bonding polymer and cured to allow milling to a controlled particle size. The aggregate is a first ceramic composite due to having a pre-ceramic polymer coating and bonding a coal-based material of significantly different composition and properties.

In FIG. 2, a schematic cross-sectional view of one particle 200 is shown wherein the coal or coal byproduct powder particle 202 is coated with a first layer of an inorganic polymer resin 204, cured to form the first ceramic composite aggregate then coated with a second pre-ceramic polymer 206 to bond multiple ceramic composite aggregates together. Particle 200 is a dual resin-coated aggregate that is mixed with multiples of other dual resin-coated aggregates, shaped and processed to form a second ceramic coal-composite component or part.

The second ceramic coal-composite part is useful in building construction and architectural elements for less cost, with greater structural integrity, less density and other desirable attributes that are not found in existing wood plastic composite components, bricks, blocks, pavers and the like available as building components in today's market.

In a first embodiment of the invention, a first aggregate is formed when coal and coal by-product particles with an approximate particle size of less than approximately 100 microns in diameter are mixed with an inorganic polymer resin that coats the coal and coal by-product particles. Subsequently, the mixture of resin and coal particles is processed to form a green body that is pyrolyzed to form a first ceramic composite wherein both the green body and the first ceramic composite contain and prevent the release and leaching out of harmful impurities in the coal and coal by-product particles.

In a second embodiment of the invention, a second aggregate is formed when multiple (>approximately 3) particles, including the fines, of the first ceramic composite are processed and sized by grinding and milling to form a powder with particle sizes ranging in diameter from approximately 0.01 micron up to approximately 5000 microns, then mixed with a pre-ceramic polymer resin selected from an inorganic polymer resin or an organic polymer resin wherein the powdered first ceramic composite and pre-polymer resin are mixed, processed and formed or shaped into a building/construction component or material before pyrolyzing at temperatures between approximately 700° C. to approximately 1100° C. to produce a ceramic coal-composite building material.

While this disclosure describes aggregates composed of coal or coal byproduct powders, the aggregate process of this invention can be utilized with any powdered material within the size range required by this technique that can withstand the processing temperatures.

The aggregate formation of the present invention allows tight control of the structure of a component produced using the aggregate. In addition, judicious selection of the aggregate composition allows control over the properties, such as fire or flame retardancy. Control of aggregate particle size and particle size distribution affects the density, porosity, compression strength, flexure strength, and water absorption of the ceramic coal-composite building material. The aggregate particles can be “re-wet” with an “aggregate binder resin” and molded into the component such as a brick, block, or other building component. After molding, the component is cured at approximately 100° C. to approximately 200° C. and pyrolyzed to between approximately 700° C. and approximately 1100° C. in inert gas or low (<approximately 1%) oxygen environment to convert the PDC polymer to ceramic.

A modification of this aspect is to convert the first aggregate (coated and bonded particles at a controlled size distribution) to ceramic by heating in inert gas or low (<approximately 1%) oxygen environment to approximately 700° C. to 1100° C. and then mixing the ceramic coated first aggregate with a resin to mold the component. In this case the resin can be nearly any type of inorganic resin such as a PDC resin or an organic resin such as polypropylene or polyethylene. For example, a fine powder first aggregate composed of ceramic coated coal or coal byproducts of particle size between approximately 5 and approximately 100 microns could be compounded (uniformly blended) into polypropylene and the first aggregate filled plastic could then be molded or extruded into a part. The first aggregate filled part would have superior properties to a part composed of polypropylene compounded with current fillers due to the tailoring of the composition of the ceramic coating to react with the polypropylene resin to improve bonding and therefore properties.

### Aggregate Formation Process

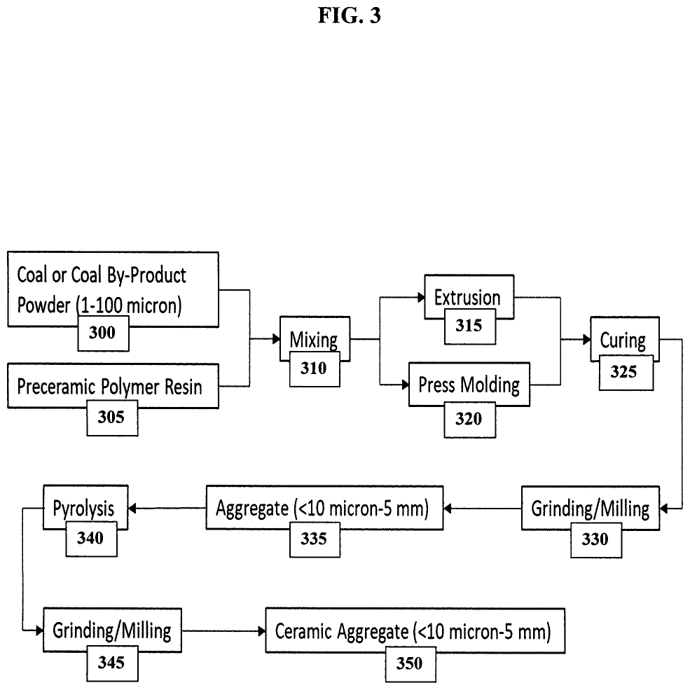

FIG. 3 is a flow diagram of a process showing coal powder and coal by-product powder 300 in a particle size ranging from approximately 1 to approximately 100 microns in diameter and a preceramic polymer resin 305 being mixed 310 until all powder particles are coated with the resin, and form a paste like consistency of resin coated powder particles which is then extruded 315 or press molded 320 into a desired shape. It should be noted that when referring to particle diameter, this refers to the “equivalent diameter” of the particles even though they may or may not be perfectly spherical. For an irregularly shaped object, the equivalent spherical diameter is the diameter of a sphere of equivalent volume. According to the IUPAC definition, the equivalent diameter of a non-spherical particle is equal to the diameter of a spherical particle which will give identical geometric, optical, electrical or aerodynamic behavior to that of the non-spherical particle being examined; sometimes referred to as the Stokes diameter for particles in non-turbulent flows. Source: IUPAC. Compendium of Chemical Terminology, 2nd ed. (the “Gold Book”). Compiled by A. D. McNaught and A. Wilkinson. Blackwell Scientific Publications, Oxford (1997). Online version (2019-) created by S. J Chalk ISBN 0-9678550-9-8. https://doi.org/10.1351/goldbook.)

The shaped resin-coated powder particles are cured 325 at temperatures between approximately 100° C. to approximately 200° C. The cured, shaped resin-coated powder is ground and milled 330 to form aggregates approximately <10 microns to approximately 5 millimeters in diameter. The aggregates are pyrolyzed 340 at temperatures between approximately 700° C. and approximately 1100° C. in inert gas or low (<approximately 1%) oxygen environment to convert the PDC polymer to ceramic. The pyrolyzed ceramic material is ground and milled 345 to produce ceramic aggregate particles of the desired size in a size range between approximately <10 microns to approximately 5 millimeters in diameter.

The aggregate particles are produced by various methods depending on the required size and size distribution needed.

The methods include:

A) Mixing powder with PDC resin and either press or extrude into plates or rods that are cured and then broken up into powder by a hammer mill and/or ball mill. The aggregate is then sized by sieving to generate the desired particle size distribution—this process has demonstrated very high strength but low density parts when used with coal powders and coal byproduct powders. The percentage of powder loading permitted by this method ranges from approximately 65% by mass to approximately 95% by mass.

B) Emulsifying the PDC resin in water using a surfactant, mixing the emulsion with the powders and molding a rod by extrusion, then drying, curing and milling as above. This method would also allow control of the coating thickness on the particles in the aggregate and the aggregate size by varying the ratio of resin to water. The powder/resin ratio for this method would be ˜approximately 60% powder to approximately 98% powder by mass.

C) Mixing the PDC resin with a solvent and then mixing the solution with powder. The coated powder would then be spray dried by forcing the mixture through a nozzle into a heated chamber to evaporate the solvent and cure the resin. This process provides tight control over the aggregate particle size, but uses flammable solvents, so its application may be limited. The powder/resin ratio for this method is ˜approximately 60% powder to approximately 98% powder by mass.

D) Emulsifying the PDC resin in water using a surfactant, mixing the emulsion with the powders. The coated powder would then be spray dried by forcing the mixture through a nozzle into a heated chamber to dry and cure the resin to produce aggregate. This process provides tight control over the aggregate particle size without the added cost of sieving, uses no flammable solvents, and would be employed to produce small size aggregates targeted for compounding into organic resins. The powder/resin ratio for this method is ˜approximately 60% powder to approximately 98% powder by mass.

E) Mixing PDC resin with coal or coal byproduct powders but using a higher resin content such that the powder makes up between approximately 2% and approximately 60% by mass of the mixture. The liquid mixture would be formed into small “beads” by adding the liquid mixture to rapidly stirred water that is heated to cure the resin. This process produces very spherical “bead” type particles that would allow higher loading of aggregate into organic polymers during the compounding step and impart improved flow of the aggregate filled resin during molding. Additional organic polymers useful in the present invention include, and are not limited to, phenolic resin, furfural alcohol, vinyl ester, epoxy, a polyolefin such as polyimide, polyamide, or engineering organic polymers, such as polyetheretherketone (PEEK), polyetherketoneketone (PEKK), polybismaleimides (BMI) and the like.

### Part or Component Formation Process

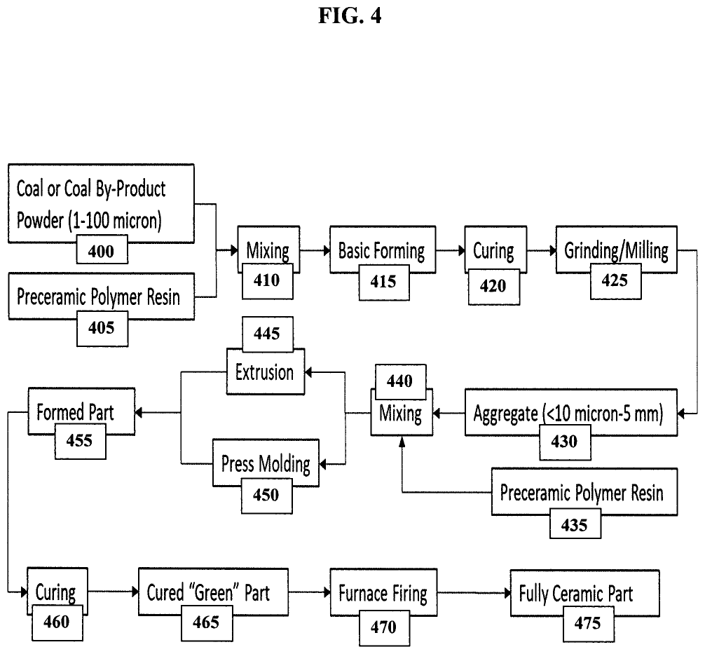

FIG. 4 is a flow diagram of the process for forming a coal-based ceramic composite material useful in building construction. Coal powder and coal by-product powder 400 in a particle size ranging from approximately 1 micron to approximately 100 microns in diameter is placed in a mixer with a preceramic polymer resin 405 and mixed 410 until all powder particles are coated with the resin, and form a paste like consistency of resin coated powder particles which is then formed 415 by extrusion or molding into a desired shape. The shaped resin-coated powder particles are cured 420 at temperatures between approximately 100° C. to approximately 200° C. The cured, shaped resin-coated powder is ground and milled 425 to form aggregates 430 approximately <10 microns to approximately 5 millimeters in diameter. The aggregates 430 are placed in a mixer with a preceramic polymer resin 435 and mixed 440 to form a second paste like consistency of dual resin-coated aggregate particles. The dual resin-coated aggregate particles 430 are extruded 445. The dual resin-coated aggregate particles 430 are extruded 445 or press molded 450 into a desired formed part 455. The formed part 455 is cured 460 at temperatures between approximately 100° C. to approximately 200° C. The cured, shaped, dual resin-coated powder forms a cured green body 465 that is pyrolyzed 470 at temperatures between approximately 700° C. and approximately 1100° C. in inert gas or low (<approximately 1%) oxygen environment to convert the cured green body 465 to a fully cured ceramic part 475.

Once the dual resin-coated aggregate is produced and sized for the intended application, the parts can be formed by virtually any forming process currently utilized for filled organic resin systems. These include compression molding, extrusion, injection molding, and casting.

Depending on the application and product form, the part or component may be converted to ceramic by heating to between approximately 700° C. and approximately 1100° C. in inert gas or low oxygen (<1% oxygen) environment to convert the PDC polymer to ceramic. The dual resin-coated aggregate may also be used as a reinforcing filler in high temperature inorganic resins or in commercially available thermoplastic resins such as polypropylene, or thermosetting resins such as epoxy. The process utilized to convert aggregate (already processed to the correct size distribution) into components maybe selected from the non-limiting examples below:

A) Mixing cured dual resin-coated aggregate with PDC resin, molding a part by pressing or other methods, curing the part at approximately 100° C. to approximately 200° C. followed by pyrolysis to between approximately 700° C. and approximately 1100° C. in inert gas or low (<1%) oxygen environment to convert the PDC polymer to ceramic. The ceramic composite part can be machined if needed for the application.

B) Mixing pyrolyzed ceramic dual resin-coated aggregate with PDC resin, molding a part by pressing or other methods, curing the part at approximately 100° C. to approximately 200° C. followed by pyrolysis to between approximately 700° C. and approximately 1100° C. in inert gas or low (<1%) oxygen environment to convert the PDC polymer to ceramic. The ceramic composite part can be machined if needed for the application.

C) Mixing the cured dual resin-coated aggregate with a high temperature stable inorganic resin, molding the part, curing the part at approximately 100° C. to approximately 200° C. followed by heat treatment at between approximately 260° C. and approximately 400° C. to fully cure the material.

D) Mixing pyrolyzed ceramic dual resin-coated aggregate with a high temperature inorganic resin, molding a part by pressing or other methods, curing the part at approximately 100° C. to approximately 200° C. followed by heat treatment at between approximately 260° C. and approximately 400° C. to fully cure the material.

E) Coating the pyrolyzed ceramic dual resin-coated aggregate with a thin layer of specially formulated inorganic resin designed to bond to thermoplastic organic resins, compounding or blending the coated aggregate into an organic thermoplastic resin such as polypropylene or polyethylene, and molding the aggregate filled organic resin into a component.

F) Coating the pyrolyzed ceramic dual resin-coated aggregate with a thin layer of specially formulated inorganic resin designed to bond to thermosetting organic resins, compounding or blending the coated aggregate into an organic thermosetting resin such as Epoxy or Vinyl ester, molding the aggregate filled organic resin into a component, and curing the thermosetting resin.

The strength, density, and porosity of the composites can be tailored within a wide range to fit the final application by controlling the materials, form factor and processing parameters during fabrication. The base materials used to produce composites are powders of coal, coal byproducts, or other powders and PDC polymer resins. The coal can be one or any mixture of lignite, subbituminous, bituminous or anthracite coals. The resins are thermoplastic or thermosetting ceramic-forming polymers. The initial material is first milled and ground (if needed) to yield powder with particle sizes ranging from approximately 0.01 micron up to approximately 100 microns. The powder is then mixed with one or any combination of inorganic polymer resins. The resin content can range from approximately 50 wt % or more down to approximately 5 wt% or less. After mixing, the resin-infiltrated coal powder is transferred to a press mold or extruder and consolidated into blocks, cylinders, or any other form using pressure and/or shear. The resulting density of the bulk is a function of the applied pressure, which can range from approximately 50 psi or less up to approximately 1000 psi or more. The pressure-formed part then undergoes a curing process to solidify the resin and the bulk body. Curing can occur at room temperature or can require elevated temperatures, depending on the resin type as well as the catalyst that is used in the case of thermosetting resins. Elevated curing temperatures can range from approximately 50° C. to approximately 210° C. The cure time can range from approximately 30 minutes or less to over approximately 24 hours, again depending on temperature and catalyst.

After the bodies are cured, they are crushed, ground, and milled to make an aggregate material analogous to the mineral and sand aggregates used in traditional cement blocks or concrete. The size and size distribution of the aggregate particles will, along with molding pressure, dictate the porosity and density of the final molded Composites. The porosity and density, in turn, dictate the strength of the Composites. The aggregate particle size can range from approximately 5 microns or less up to approximately 5 millimeters. Once the desired mixture of aggregate is achieved, it is mixed with more polymer resin. The polymer resin can be the same resin that was used to produce the aggregate or a different polymer resin. The inorganic polymer resins used in this technology are described extensively in prior U.S. patent application Ser. No. 15/964,551, “Inorganic Polymers and Compositions for Improved 3D Printing of Larger Scale Ceramic Materials and Components,” filed on Apr. 27, 2018; U.S. Provisional Patent Application Ser. No. 62/373,678, “Fracking Proppant and Method of Manufacture,” filed Aug. 11, 2016, now U.S. patent application Ser. No. 16/324,843 filed as PCT Application No. PCT/US2017/046559 on Aug. 11, 2017, now U.S. Pat. Pub. No.

2019/0169491, published Jun. 6, 2019; U.S. Provisional Patent Application Ser. No. 62/644,923, “Composite Tile and Method of Manufacture,” filed Mar. 19, 2018, now PCT/US19/23004, filed as PCT Application No. PCT/US2019/023004 on Mar. 19, 2019, now WO2019/183118, published Sept. 26, 2019; U. S. Provisional Patent Application Ser. No 62/413,342, “Functional Composite Particles,” filed on Oct. 26, 2016, now U.S. patent application Ser. No. 16/894,638 filed Jun. 5, 2020 as a continuation of U.S. patent application Ser. No. 16/099,918 (now abandoned) filed as PCT/US 2017/059541 on Oct. 26, 2017, now U.S. Pat. Pub. No. 2020/0299198, published Sep. 24, 2020; U.S. Provisional Patent Application Ser. No. 62/413,381, “Carbon Ceramic Composites and Methods,” filed on Oct. 26, 2016, now U.S. patent application Ser. No. 16/345,577 filed as PCT/US 2017/058626 filed on Oct. 26, 2017, now U.S. Patent Pub. No. 2019/0292441-A1, published Sep. 26, 2019; and U.S. Provisional Patent Application Ser. No. 62/413,385, “Complex Composite Particles and Methods,” filed on Oct. 26, 2016, now U.S. patent application Ser. No. 16/337,482 filed as PCT/US 2017/058616 filed Oct. 26, 2017 now U.S. Patent Pub. No. 2019/0345071-A1, published Nov. 14, 2019. The entire disclosure of each of the applications listed in this paragraph is incorporated herein by specific reference thereto.

The amount of resin added at this stage can range from approximately 5 wt% or less up to approximately 50 wt % or more. The coated aggregate material is then placed in a press mold or extruder mill and the material is formed into the final shape. The pressure used can be the same as or different than the pressure used to create the aggregate. This pressure can vary from approximately 20 psi or less up to approximately 1000 psi or more. Once the composites have been pressed or extruded, they undergo another curing process. The cure time and temperatures ranges are the same as those for producing the aggregate.

After the composites are cured, they are in the “plastic state” or, in the case of ceramic-forming materials, the “green state”. The ceramic-forming green composites are then placed in an atmosphere-controlled furnace and fired to high temperature over times ranging from 4 hours to 7 days depending on the mass of components (such as bricks) in the furnace. The final firing temperature can range from approximately 700° C. or less up to approximately 1100° C. or more. The firing time, depending on the composite size, can range from approximately 4 hours or less to approximately 7 days or more. During the firing process, coal is converted to pure carbon by driving off the low molecular weight hydrocarbons. At the same time, the ceramic-forming polymer resins decompose and molecular rearrangements occur that lead to the formation of a ceramic material; this produces a carbon/ceramic composite.

The pyrolysis process is similar to that described in U.S. patent application Ser. No. 15/964,551, “Inorganic Polymers and Compositions for Improved 3D Printing of Larger Scale Ceramic Materials and Components,” filed on Apr. 27, 2018; U. S. Provisional Patent Application Ser. No. 62/373,678, “Fracking Proppant and Method of Manufacture,” filed Aug. 11, 2016, now U.S. patent application Ser. No. 16/324,843 filed as PCT Application No. PCT/ US2017/046559 on Aug. 11, 2017, now U.S. Pat. Pub. No. 2019/0169491, published Jun. 6, 2019; U.S. Provisional Patent Application Ser. No. 62/644,923, “Composite Tile and Method of Manufacture,” filed Mar. 19, 2018, now PCT/US19/23004, filed as PCT Application No. PCT/US2019/023004 on Mar. 19, 2019, now WO2019/183118, published Sep. 26, 2019; the entire disclosure of each of the applications listed in this paragraph is incorporated herein by specific reference thereto.

The ceramic materials form a coating that infuses and encapsulates the high carbon areas in the material. This renders the composites highly fire and heat resistant. The chemistry involved in the production of carbon/ceramic composites from coal/polymer resin precursors is described in greater detail in including, but not limited to, U.S. Provisional Patent Application Ser. No. 62/373,678, “Fracking Proppant and Method of Manufacture,” filed Aug.11, 2016, now U.S. patent application Ser. No. 16/324,843 filed as PCT Application No. PCT/ US2017/046559 on Aug. 11, 2017, now U.S. Pat. Pub. No. 2019/0169491, published Jun. 6, 2019; U.S. Provisional Patent Application Ser. No. 62/644,923, “Composite Tile and Method of Manufacture,” filed Mar. 19, 2018, now PCT/US19/23004, filed as PCT Application No. PCT/US2019/023004 on Mar. 19, 2019, now WO2019/183118, published Sep. 26, 2019; the entire disclosure of each of the applications listed in this paragraph is incorporated herein by specific reference thereto.

The key difference between the present invention and the prior art is in the aggregate-production step and the multimodal particulate composition of the final composite. Prior art utilizes un-coated, monomodal particulates that are within a relatively small size range (approximately 0.1 micron to approximately 50 microns in diameter); whereas, the ceramic composite described in this disclosure uses resin-coated, aggregate particles that are multimodal with particle sizes that range from a diameter of approximately 5 millimeters or larger-sized “aggregate” down to approximately 5 microns to approximately 10 micron-scale sized “fine” aggregates. The ratio of aggregate to fines is crucial to both the final properties of the composite and its ability to survive pyrolysis processing. Using larger-sized aggregate particles allows for greater spacing between particles and therefore increased porosity. This increase in porosity increases the elasticity of the material, thus making it less susceptible to the stresses caused by the firing process. The chemical interactions that occur between the carbon in the coal and the ceramic matrix formed from the resin are responsible for the vastly improved strength and toughness of composite in relation to traditional clay, concrete brick, block or other cement-based building materials.

Another important difference between the present invention and prior art can be seen in the physical structure of the material on the micron and millimeter level. The coal-ceramic invention disclosed in U. S. Provisional Patent Application Ser. No. 62/644,923, “Composite Tile and Method of Manufacture,” filed Mar. 19, 2018, now PCT/US19/23004, filed as PCT Application No. PCT/US2019/023004 on Mar. 19, 2019, now WO2019/183118, published Sep. 26, 2019, is incorporated herein by specific reference thereto and contains relatively small coal particles of all roughly the same size <approximately 50 microns. Thus, prior to the present invention the particle size of coal and coal by-products were “monomodal” in particulate makeup.

Ceramic structures of larger scale, greater strength and bulk are possible with the present invention using numerous sized aggregate particles coated in PDC matrix and each of those aggregate particles is, in turn, made up of smaller, relatively uniform particles coated and bonded by PDC matrix. Prior to the present invention, particles utilized were primarily of one size in plastic resins and the particles were not coated and bonded together with an inorganic PDC resin to enhance properties. This can be seen visually by microscopy analysis, which will reveal a material from the present invention containing aggregate particles of numerous different sizes across a very broad range of <approximately 50 microns to over approximately a millimeter in effective diameter.

The mechanical properties of composites produced by this method exceed those of load bearing concrete masonry units and structural hollow brick masonry units by a fair margin. For example, normal weight concrete masonry units have a compressive strength of ˜approximately 13.8 MPa (2001.5 psi) and a density of ˜approximately 2000 kg/m³(2.0g/cc) whereas composites of the present invention have a compressive strength of in excess of approximately 125 MPa (18129.7 psi) and a density of ˜approximately 1300 kg/m³(1.3 g/cc) The mechanical properties of composites can be driven higher by increasing molding pressures at the aggregate producing phase and/or at the composite molding phase, reducing aggregate size, increasing resin content at the aggregate producing phase and/or the composite molding phase (increased resin means increased cost) or changing resin type. The thermal properties of composites such as maximum use temperature can be enhanced by adding alkaline metal carbonates or hydroxides, such as magnesium carbonate or magnesium hydroxide, to the aggregate mix. During firing the carbonates and hydroxides break down to yield magnesium oxide, which is a highly refractory material and increases the high temperature stability of the composites.

Another property of composites that has been discovered during initial testing is that the materials, when in ceramic form, have conductivities comparable to that of steel. This could lead to numerous applications of composites in cold and icy/snowy environments where the conductivity of the composite components could be employed to create self-heating sidewalks, driveways, roofs, walls, and the like that could either prevent ice buildup or rapidly thaw ice on such structures.

Another embodiment of the invention is firing the loose aggregate material prior to first rewetting it with a thermosetting or thermoplastic resin and forming the rewetted aggregate material into a bulk part. Pre-firing the aggregate converts the coal to more structured and stable carbon and reduces the resin matrix to a stable ceramic state. This gives the material excellent fire-retardant properties. The now-pyrolyzed aggregate can be rewet a second time with either thermosetting or thermoplastic resins to produce a plastic-ceramic composite material. This material is produced by rewetting and pressing the aggregate or by rewetting and extruding. The ceramic-filled plastic composite can be used as siding, decking, and other laminar plank-like structures.

Another embodiment of the invention is using the coal-based aggregate processing method to produce coal-based mortars and grouts. Present mortars and grouts are made using mineral aggregates, Portland cement, and other cementitious materials. A similar type of material can be made using the coal-resin aggregate system to produce the particulates and using either self-curing polymer resins or traditional cement to bind the particulates and the bricks/blocks.

Applications of the composites described in the prior art include industry-standard sized building materials with improved strength and toughness, as well as decreased density and other improvements in properties over the prior art and existing industry standards. Other end uses of the carbon ceramic composite include, but are not limited to, conductivity, fire-retardant properties, mortar and grout, cement manufacture, siding, decking, building/architectural structures and the like.

Table 1 below lists the Materials and Processes utilized by the Invention and demonstrated by the Examples. The starting powders have a particle dimension wherein the diameter of each particle is <approximately 100 microns.

TABLE I
Materials and Processes

| Starting | Starting | | | |
|---|---|---|---|---|
| Powders | Powders (Most | Powder | | |
| (Preferred | Preferred | Coating PDC | Aggregate | Final Forming and |
| Range) | Range) | Resin | Binder Resin | Thermal Process |
| Coal powders | Coal powders | Thermosetting | Thermosetting | Molding, Curing, and |
| (>approximately | (>approximately | Inorganic | Inorganic | Pyrolysis to |
| 0.1 micron, | 1 micron, | PDC Resins | PDC Resins | approximately 700° C.- |
| <approximately | <approximately | | | approximately 1100° C. |
| 100 micron) | 50 micron) | | | |
| Coal Byproduct | Coal Byproduct | Thermoplastic | Thermoplastic | Molding, Curing, and |
| powders | powders | Inorganic | Inorganic | Thermal Treatment to |
| (>approximately | (>approximately | PDC Resins | PDC Resins | approximately 260° C.- |
| 0.1 micron, | 1 micron, | | | approximately 400° C. |
| <approximately | <approximately | | | |
| 100 micron) | 50 micron) | | | |
| Other powders | Other powders | | | Blending with an |
| as additives | as additives | | | organic resin |
| (>approximately | (>approximately | | | (compounding) and |
| 0.1 micron, | 1 micron, | | | molding |
| <approximately | <approximately | | | |
| 100 micron) | 50 micron) | | | |

### EXAMPLE 1

### Process for Producing Coal Byproduct Aggregate via Powder Pressing

### Materials

1. Coal powder or Coal byproduct material of any type

2. Inorganic thermosetting PDC resin

### Procedure

If the byproduct material is not already in a powdered form as received, mill the material to a sub approximately 50 micron powder.

Mix coal byproduct powder with catalyzed preceramic resin in a ratio of approximately 70 mass percent coal to approximately 30 mass percent resin. Mix the material using a mixing machine that is analogous to a cooking-style mixer. For example, a six-quart KitchenAid mixer is used in the present example, however a sigma blade mixer, a planetary, or double planetary mixer would also work. Mixing time is a function of the amount of material being mixed and the size of the mixer. For approximately 1 kilogram of material in an approximately 6 quart mixer at low speed, mixing lasts for approximately 30 minutes to ensure full dispersion of the resin and sufficient coating of the powder particles.

After mixing is completed, the resin-coated powder is loaded into a pressing mold. Any shape is sufficient, such as an approximately 6 inch×approximately 6 inch square steel mold. The powder is then pressed in the mold to ˜approximately 1000 psi to fully compact the material into a greenbody.

The compressed greenbody is then removed from the mold and cured in an oven to a maximum temperature of approximately 180° C. for a minimum of approximately 1 hour to cure the resin. The body is now in the plastic or “green” state.

The plastic body is then milled and ground into aggregate and particulates ranging from sub approximately 50 to approximately 1500 microns. The bulk part is broken down using a hammer mill. A blade-type grinder is then used to further break down the aggregate to the proper size.

### EXAMPLE 2

### Process for Producing Coal-based Aggregate by Extrusion

### Materials

1. Coal powder or Coal of any type

2. Preceramic thermosetting polymer resin

3. Silicone-based surfactant

4. water

### Procedure

If the coal is not already in a powdered form as received, mill raw coal to a sub approximately 50 micron powder. If starting with powdered coal, the powder should be sub approximately 50 microns.

Make a water-in-resin emulsion by mixing resin, surfactant, and water. First disperse the surfactant in the resin at a ratio of approximately 5 phr (approximately 5 parts surfactant per hundred parts resin).

Then, disperse water in the resin-surfactant mix at a ratio of approximately 45 phr. Use an emulsion maker or a high shear mixer to properly disperse the water in resin and form a uniform, stable emulsion.

Mix coal powder with catalyzed resin emulsion in a ratio of approximately 55 mass percent coal powder to approximately 45 mass percent emulsion. Mix the material using a pugmill, clay mixer, or a similar style machine. Mixing time is a function of the amount of material being mixed and the size of the mixer. For approximately 1 kilogram of material in an approximately 6 quart mixer at low speed approximately 20 rpm, mixing lasts for approximately 30 minutes to ensure full dispersion of the resin and sufficient coating of the powder particles. The resulting material is very clay-like.

If the material is mixed in a pugmill, then it can be immediately extruded after mixing is complete. The material can be extruded into cylinders or rectangular blocks. If the material is mixed in a different type of clay mixer, it can be removed in whatever manner is most effective and either left in loose form to cure or further process through some form of extruder apparatus to consolidate the material.

After being processed, the resulting “coal clay” can be dried and cured in either loose or consolidated form. The first step is a “drying step” in which the material is warmed to approximately 90° C. to drive off the water held in the “clay”. The duration of the drying step is a function of the size and thickness of the formed body and can range from approximately 1 hour to approximately 3 days. After sufficient drying, the temperature is raised to a maximum of 180° C. and held for a minimum of approximately 1 hour in order to cure the resin matrix.

The dried and cured plastic body is then milled and ground into aggregate and particulates ranging from sub approximately 50 to approximately 1500 microns. The bulk part is broken down using a hammer mill. A blade-type grinder is then used to further break down the aggregate to the proper size.

### EXAMPLE 3

Process for Fabricating Fired Coal-based Composite Materials from Aggregate by Pressing Method

### Materials

1. Coal-based aggregate produced by one of the two above methods

2. Preceramic thermosetting polymer resin

The aggregate is mixed with preceramic resin at a ratio of approximately 15 weight percent resin to approximately 85 weight percent aggregate.

The aggregate is rewet with an aggregate binding resin, then loaded into a mold to form the material into the final shape, be that brick, block, or another form. The material is compressed to approximately 50 psi to approximately 250 psi depending on the particle size of the aggregate in the mold to compact the aggregate and ensure optimum contact between the particles.

The formed part can be either cured in the mold it was formed in or removed from the mold for curing. The part is cured to a maximum temperature of approximately 90° C. and held for a minimum of approximately 2 hours. If cured in the mold, the part is then removed from its mold after curing.

The cured part is then transferred to an atmosphere-controlled furnace and fired to approximately 1000° C. under nitrogen atmosphere to convert the resin matrix to ceramic and the coal to more ordered carbon. The resulting part is a fully ceramitized coal-composite building brick or block that is analogous to standard fired clay bricks or blocks. Coal composite bricks and blocks can be made to any industry standard size such as modular sized bricks of approximately 2¼ inches×approximately 3⅝ inches×approximately 7⅝ inches.

### EXAMPLE 4

Process for Fabricating Fired Coal-Derived Composite Parts from Aggregate by Extrusion Method

### Materials

1. Coal-based aggregate produced by one of the two above methods

2. Preceramic thermosetting polymer resin

3. Silicone based surfactant

4. Water

A water-in-resin emulsion is made by mixing resin, surfactant, and water. First the surfactant is dispersed in the resin at a ratio of approximately 5 phr. Then, water is dispersed in the resin-surfactant mix at a ratio of approximately 45 phr. An emulsion maker or high shear mixer is used to properly disperse the water in the resin and form a uniform, stable emulsion.

Coal-based aggregate material is mixed with the resin-water emulsion at a ratio of approximately 82 weight percent to approximately 18 weight percent aggregate to emulsion. The material is mixed using a pugmill, clay mixer, or a similar style machine. Mixing time is a function of the amount of material being mixed and the size of the mixer. For approximately 1 kilogram of material in an approximately 6 quart mixer at low speed, mixing lasts for approximately 30 minutes to ensure full dispersion of the resin and sufficient coating of the powder particles. The resulting material is clay-like.

If the material is mixed in a pugmill, then it can be immediately extruded after mixing is complete. The material can be extruded into any shape needed. If the material is mixed in a different type of clay mixer, it is then transferred to an extrusion apparatus of some form to extrude the material into its final shape. The material could also be press-molded, using light pressure in a mold to form the material to the desired size and shape.

After being processed, the resulting “coal clay” parts are dried and cured. The first step is a “drying step” in which the material is warmed to approximately 90° C. to drive off the water held in the emulsion. The duration of the drying step is a function of the size and thickness of the formed body. After sufficient drying, the temperature is raised to a maximum of approximately 180° C. for a minimum of approximately 2 hours in order to cure the resin matrix.

The cured parts are then transferred to an atmosphere-controlled furnace and fired to approximately 1000° C. under nitrogen atmosphere to convert the resin matrix to ceramic and the coal to more ordered carbon. The resulting part is a fully ceramitized coal-composite building brick or block that is analogous to standard fired clay bricks or blocks. Coal composite bricks and blocks can be made to any industry standard size, such as, modular sized bricks of approximately 2¼ inches×approximately 3⅝ inches×approximately 7⅝ inches.

### EXAMPLE 5

Process for Fabricating Coal-Derived Inorganic Resin Composites from Aggregate by Pressing Method

### Materials

1. Coal-based aggregate produced by one of the two above methods

2. Thermosetting or Thermoplastic polymer resin

The aggregate produced by the methods in either Example 1 or Example 2 is first fired in an atmosphere-controlled furnace to a maximum temperature of approximately 1000° C. The now pyrolyzed aggregate is mixed with an inorganic high temperature polymer resin at a ratio of approximately 31.5 weight percent resin to approximately 68.5 weight percent aggregate.

The rewet aggregate is then loaded into a mold to form the material into the final shape, be that brick, block, panel, or another form. The material is compressed to approximately 1000 psi in the mold to compact the aggregate and ensure optimum contact between the particles.

The formed part can be either cured in the mold it was formed in or removed from the mold for curing. Parts made containing thermoplastic inorganic resin can be molded as a thermoplastic and then hardened by heating to approximately 210° C. to approximately 260° C. For parts made from thermosetting resins, the part is cured to a maximum temperature of approximately 250° C. Some resins will require the curing to take place under inert gas atmosphere at the higher temperature ranges. If cured in the mold, the part is then removed from its mold after curing.

In summary, the invention constitutes a class of novel composite materials based on the non-combustion use of coal, and coal by-products. The coal and coal by-products are processed in a manner that coats and seals in the harmful impurities present in both coal and coal by-products within a strong, tough polymer-derived ceramic (PDC) matrix to prevent the impurities from leaching out during use of the materials. The sealed materials are further bonded with additional PDC polymer materials and molded into components. For the purposes of this disclosure the materials can be called “composites”. The components are then thermally processed by heating to approximately 350° C. for an inorganic plastic component or to approximately 1000° C. to produce coal and/or coal by-product filled ceramic materials.

The coal and coal-byproduct based composite materials of the present invention are especially useful as construction materials and building/architectural components such as bricks, blocks, siding panels, support columns, and pavers due to their lower density, superior flexural strength, higher compressive strength, and greater toughness relative to current cement-based or brick type building materials. The products of the present invention meet the need for environmentally safe, durable, strong, dense, light weight, multifunctional building materials that are in demand. Table II below shows a comparison of existing commercial building materials and the corresponding materials (X-BRIX and X-BLOX) produced by the compositions and processes described in this application showing a dramatic improvement in strength properties despite having lower densities than current cement blocks and bricks.

TABLE II
Comparison of Density, Compressive Strength and Flexure Strength

| Material/ | Density | Compressive | Flexure |
|---|---|---|---|
| Component | (g/cc) | Strength (psi) | Strength (psi) |
| Construction Grade | approximately 2.3 | approximately 4,400 | approximately 800 |
| Cement Block | | | |
| Class AA Brick | approximately 1.9 | approximately 2,845 | approximately 712 |
| X-BRIX sample | approximately 1.45 | approximately 12,285 | approximately 4815 |
| X-BLOX sample | approximately 1.45 | approximately 17,694 | approximately 5918 |

Table II shows that X-BRIX and X-BLOX have the same density (approximately 1.45 g/cc) which is less than the density of construction grade cement block and Class AA Brick. Thus, the X-BRIX and X-BLOX products of present invention are lighter weight and offer a considerable advantage when handling and transporting. A comparison of compressive strength and flexure strength is as follows: X-BRIX has a compressive strength that is approximately 2.79 times greater than cement block and approximately 4.3 times greater than Class AA brick. X-BRIX has a flexure strength that is approximately 6.0 times greater than cement block and approximately 6.76 times greater than Class AA brick.

X-BLOX is even stronger when compared to the standard construction grade materials. X-BLOX has a compressive strength that is approximately 4.0 times greater than cement block and approximately 6.2 times greater than Class AA brick. X-BLOX has a flexure strength that is approximately 7.4 times greater than cement block and approximately 8.3 times greater than Class AA brick.

Thus, the lighter weight X-BRIX and X-BLOX materials of the present invention can withstand 3 to 6 times greater compressive strength before crumbling than standard construction grade cement block. X-BRIX and X-BLOX materials of the present invention can withstand approximately 6 to approximately 9 times greater flexure strength before rupturing than Class AA brick.

Additional advantages of the present invention are:
Shorter production time—it takes 28 days for concrete to reach maximum strength while the components described in the art need only to cure at temperature (approximately 210-approximately 350° C., or approximately 1000° C.) for a maximum of approximately 4 hours.
Controllable and lower porosity than standard construction bricks, blocks or cement panels which translates to less water absorption and therefore less damage due to freeze-thaw environments such as over half the United States.
The materials of the art, due to the inorganic and non-water based PDC binder, are immune to common issues affecting cement type building materials such as acid rain, salt corrosion, and automotive fuel/lubricant spills.

Although specific advantages have been enumerated above, various embodiments may include some, none, or all of the enumerated advantages.

Modifications, additions, or omissions may be made to the systems, apparatuses, and methods described herein without departing from the scope of the disclosure. For example, the components of the systems and apparatuses, compositions, methods and processes can be integrated or separated. Moreover, the operations of the systems and apparatuses, compositions, processes and methods disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

The term “approximately” is similar to the term “about” and can be +/- 10% of the amount referenced. Additionally, preferred amounts and ranges can include the amounts and ranges referenced without the prefix of being approximately.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

We claim:

1. A coal-based ceramic composite aggregate having one resin coating that prevents the release or leaching out of harmful impurities from coal or coal by-products, comprising:
a plurality of powdered coal particles and a plurality of powdered coal by-product particles each having a particle size effective diameter ranging from approximately 0.01 micron up to approximately 100 microns;
a pre-ceramic polymer resin selected from an inorganic polymer resin mixed with the plurality of powdered coal particles and the plurality of powdered coal by-product particles to form a plurality of resin-coated coal particles, wherein the plurality of resin-coated coal particles bond together during mixing to produce a coal-based composite aggregate with multimodal particle size distribution in an effective diameter range between approximately 5 microns up to approximately 5 millimeters and the coal-based composite aggregate is molded or extruded or subsequently pressure-formed before curing to form a green body composite aggregate that is subsequently pyrolyzed to produce a coal-based ceramic composite aggregate.

2. The coal-based ceramic composite aggregate of claim 1, wherein the coal is selected from at least one of lignite, sub-bituminous, bituminous, and anthracite.

3. The coal-based ceramic composite aggregate of claim 1, wherein the coal by-product is selected from at least one of garbage of bituminous, shale-coal, and coal combustion residuals.

4. The coal-based ceramic composite aggregate of claim 3, wherein the coal combustion residual is selected from at least one of fly ash, bottom ash, coke, or partially burned coal.

5. The coal-based ceramic composite aggregate of claim 1, wherein the inorganic polymer resin is selected from at least one of a polysiloxane polymer, a silicone resin, a polycarbosilane polymer, a silazane polymer, and ceramic forming sol gel precursors.

6. The coal-based ceramic composite aggregate of claim 1, wherein the inorganic resin content of the mixture of resin and powdered coal and powdered coal by-products is in a range of approximately 5 weight % to approximately 50 weight % of the total mixture.

7. The coal-based ceramic composite aggregate of claim 1, wherein the combined content powdered coal particle and powdered coal by-product particle content is in a range of approximately 60 weight % to approximately 98 weight % of the total mixture.

8. The coal-based ceramic composite aggregate of claim 1, wherein the temperature for curing is in a range between approximately 50° C. and approximately 210° C.

9. The coal-based ceramic composite aggregate of claim 1, wherein the temperature for pyrolyzing to produce a coal-based ceramic is in a range between approximately 700° C. and approximately 1100° C.

10. A coal-based ceramic composite having a dual coating of resin for production of durable, building construction material, comprising:
a plurality of powdered coal particles and a plurality of powdered coal by-product particles each having a particle size effective diameter ranging from approximately 0.01 micron up to approximately 100 microns;
a first pre-ceramic polymer resin selected from an inorganic polymer resin, wherein the powdered coal and powdered coal by-product is mixed with the inorganic polymer resin to form a plurality of resin-coated powdered coal particles and powdered coal by-product particles to produce afirst coal-based composite aggregate that is processed to produce a first coal-based ceramic composite;
the first coal-based ceramic composite is crushed, ground, and milled to make a plurality of aggregate particles wherein a multimodal particle size distribution is in a range from approximately 5 microns to approximately 5 millimeters in effective diameter;
the plurality of aggregate particles having multimodal particle size distribution is mixed with a second pre-ceramic polymer resin to form a dual resin-coated coal-based composite that is molded or extruded or pressure-formed before curing to form a green body building or construction part that is pyrolyzed to produce a dual resin-coated, coal-based ceramic composite.

11. The dual resin-coated, coal-based ceramic composite in claim 10, wherein the second pre-ceramic polymer resin mixed with the aggregate particles having multimodal particle size distribution is selected from at least one of an inorganic polymer resin, an organic polymer resin or a mixture thereof.

12. The dual resin-coated, coal-based ceramic composite in claim 11, wherein the inorganic polymer resin is at least one of a polysiloxane polymer, a silicone resin, a polycarbosilane polymer, a silazane polymer, and ceramic forming sol gel precursors.

13. The dual resin-coated, coal-based ceramic composite in claim 11, wherein the organic polymer resin is at least one of phenolic resin, furfural alcohol, vinyl ester, epoxy, a polyolefin such as polypropylene, polyethylene, polyimide, polyamide, or engineering organic polymers.

14. The dual resin-coated, coal-based ceramic composite in claim 10, wherein the temperature for curing is in a range between approximately 50° C. and approximately 210° C.

15. The dual resin-coated, coal-based ceramic composite in claim 10, wherein the temperature for pyrolyzing to produce a coal-based ceramic is in a range between approximately 700° C. and approximately 1100° C.

16. The dual resin-coated, coal-based ceramic composite in claim 10, wherein the construction part used in building and construction is selected from at least one of blocks, planks, bricks, siding panels, support columns, pavers and decorative masonry components.

17. The dual resin-coated, coal-based ceramic composite of claim 10, wherein the composite building and construction materials have compressive strength in a range in excess of approximately 12,000 psi to approximately 18,000 psi which is four to nine times greater than existing construction materials of similar dimensions and applications.

18. The dual resin-coated, coal-based ceramic composite of claim 10, wherein the composite building and construction materials have flexure strength in a range in excess of approximately 4800 psi and approximately 6000 psi which is six to seven times greater than existing construction materials of similar dimensions and applications.

19. A non-toxic, coal-based ceramic composite material for fabricating construction, building and architecture components comprising:
a plurality of powdered coal particles and a plurality of powdered coal by-product particles;
a pre-ceramic polymer resin selected from an inorganic polymer resin to coat the plurality of powdered coal particles and the plurality of powdered coal by-product particles and form a plurality of resin-coated coal particles, wherein the plurality of resin-coated coal particles bond together during mixing to form a plurality of composite aggregates with multimodal particle size distribution in an effective diameter range between approximately 5 microns up to approximately 5 millimeters and the coal-based composite aggregate is molded or extruded or subsequently pressure-formed before curing to form a green body composite aggregate;
an aggregate bonding resin to coat and re-wet the green body composite aggregate to facilitate the molding of a coal-based, ceramic composite for construction, building and architecture components.

20. The non-toxic, coal-based ceramic composite of claim 19, wherein the construction, building and architecture components are selected from the group consisting of a brick, a block, a panel, a plank, a siding, a support column, a cement panel, a mortar composition, a grout composition, a bulk shape, and a gargoyle.
